(19) United States
(12) Patent Application Publication
(10) Pub. No.: US 2003/0055167 A1
(43) Pub. Date: Mar. 20, 2003

(54) Siloxane containing macromonomers and dental composites thereof

(75) Inventors: Joachim E. Klee, Radolfzell (DE); Uwe Walz, Konstanz (DE); Jurgen Fiedler, Konstanz (DE); Rolf Mulhaupt, Freiburg (DE); Holger Frey, Freiburg (DE); Ekkehardt Muh, Freiburg (DE)

Correspondence Address: Douglas J. Hura, DENTSPLY INTERNATIONAL INC., 570 West College Avenue, York, PA, 17405-0872, US

(73) Assignee: DENTSPLY DeTrey GmbH

(21) Appl. No.: 10/213,050

(22) Filed: Aug. 6, 2002

Related U.S. Application Data
(63) Continuation of application No. 10/074,725, filed on Feb. 12, 2002.
(63) Continuation of application No. 09/626,200, filed on Jul. 26, 2000, now abandoned.
(60) Provisional application No. 60/146,093, filed on Jul. 28, 1999.

(51) Int. Cl. C08F 8/00

(52) U.S. Cl. 525/100

(57) ABSTRACT

The invention concerns macromonomers of a molecular weight of at least M≧500 g/mol containing siloxane groups. The macromonomers are usable as polymerizable monomers in a dental/medical composite comprising further at least a polymerizable monomer, an organic or inorganic acid or an acidic monomer, a stabilizer, an initiator, pigments and an organic or inorganic filler. The dental/medical composite is usable as a dental restorative material for filling and restoring teeth, making inlays and onlays, for artificial teeth, for sealing and surface modification materials, usable as temporary crown and bridge material. Furthermore, the macromonomers are usable for filler surface modification, as precursors for siloxane condensation products or as precursor for preparation of nanoparticles containing active polymerizable moieties.

### RELATED APPLICATIONS

This application is a continuation of Ser. No. 09/626,200 filed Jul. 26, 2000 (Case KON-76) which claims the benefit of U.S. Provisional Application Serial No. 60/146,093 filed Jul. 28, 1999 (Case KON-76 PRO).

### TECHNICAL FIELD

This invention relates to siloxane containing macromonomers and dental composites thereof.

### BACKGROUND OF THE INVENTION

In the last decade dental restorative materials, especially dental composites, becomes a high interest. Manly the aesthetic quality of the filling material should be improved in comparison to amalgam and a possible toxicological risking should be avoided.

Presently, commercial dental composites exhibit outstanding mechanical properties, such as compressive strengths ranging from 300 to 500 MPa and flexural strengths ranging from 130 to 170 MPa. Furthermore, over the past years they have been improved with respect to abrasion resistance, marginal integrity, fatigue behavior and their optical properties. Nevertheless, a volumetric shrinkage of about 2.5 to 4.0% takes place during the polymerization of these composites. This shrinkage may lead to marginal gap formation, microfractures in the material and sometimes enamel edge cracks. Secondary caries may arise as a result of these defects. Therefore an important objective is to develop new composite materials that exhibit reduced volumetric shrinkage without sacrificing other beneficial properties.

The volumetric shrinkage is influenced by two different effects: firstly, during polymerization the van der Waals distance of the monomers are replaced by covalent bonds and secondly, the packing density of the polymers increases in comparison to that of the monomers. There are several possibilities to reduce the volumetric shrinkage.

In order to reduce volumetric shrinkage and improve mechanical properties materials that comprises polymerizable moieties and additionally siloxane groups were proposed in the past years. Organosiloxanes described by prior art are mono (meth)acrylates having one siloxane moiety (U.S. Pat. No. 5,192,815), polyfunctional compounds as well as the so-called ORMOCERe materials (DE 3903407, DE 4133494). Due to the relatively high viscosity of these materials they are only usable in combination with reactive diluents. It is well-known that low-molecular methacrylates are less or non biocompatibility and have a relatively high volumetric shrinkage.

An aim of the invention was to reduce shrinkage by partial or complete replacement of low-molecular polymerizable monomers by the novel siloxane comprising macromonomers.

### BRIEF DESCRIPTION OF THE DRAWINGS

FIG. 1—Transmission electron microscopic photograph of nano-scaled particles

FIG. 2—Transmission electron microscopic photograph of nano-scaled particles

FIG. 3—Element specific image—TEM image of the acid catalyzed condensation product (film on carbon-grid

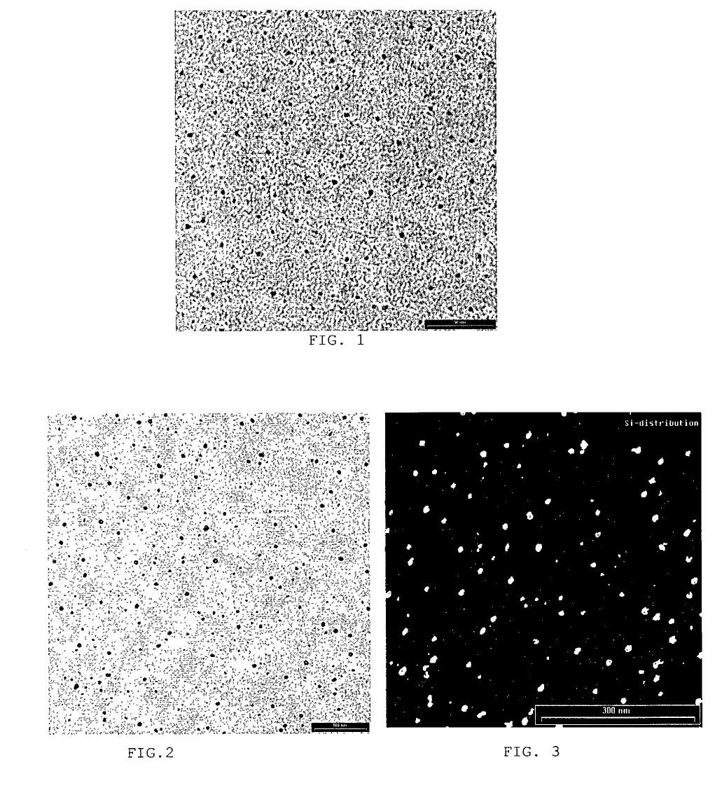

### PREFERRED EMBODIMENTS OF THE INVENTION

The invention concerns macromonomers of a molecular weight of at least M≧500 g/mol containing at least one siloxane group that are described by the following generally formula:

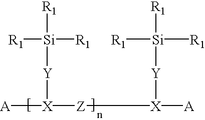

wherein

A is a polymerizable moiety, preferably an olefinic double bond, most preferably acrylate or methacrylate,

R₁ is an C₁ to C₁₈ oxyalkyl, a C₅ to C₁₈ oxycycloalkyl or a C₅ to C₁₅ oxyarylene, C₁ to C₁₈ alkyl, a C₅ to C₁₈ cycloalkyl or a C₅ to C₁₅ arylor heteroaryl

X is N or a substituted or unsubstituted C₁ to C₁₈ alkylene, a C₁ to C₁₈ oxyalkylene or C₁ to C₁₈ carboxyalkylene

Y is an C₁ to C₁₈ alkylene, C₁ to C₁₈ oxyalkylene or an urethane —O—CO—NH— linking moiety

Z is an C₁ to C₁₈ alkylene, a C₅ to C₁₈ cycloalkylene or a C₅ to C₁₅ arylene or heteroarylene,

n is an integer.

The dental/medical composite is usable as a dental restorative material for filling and restoring teeth, making inlays and onlays, as core build-up materials, for artificial teeth, for sealing and coating materials, usable as temporary crown and bridge material.

Examples of the used macromonomers containing alkoxysilyl groups are given in formulas 1 to 15.

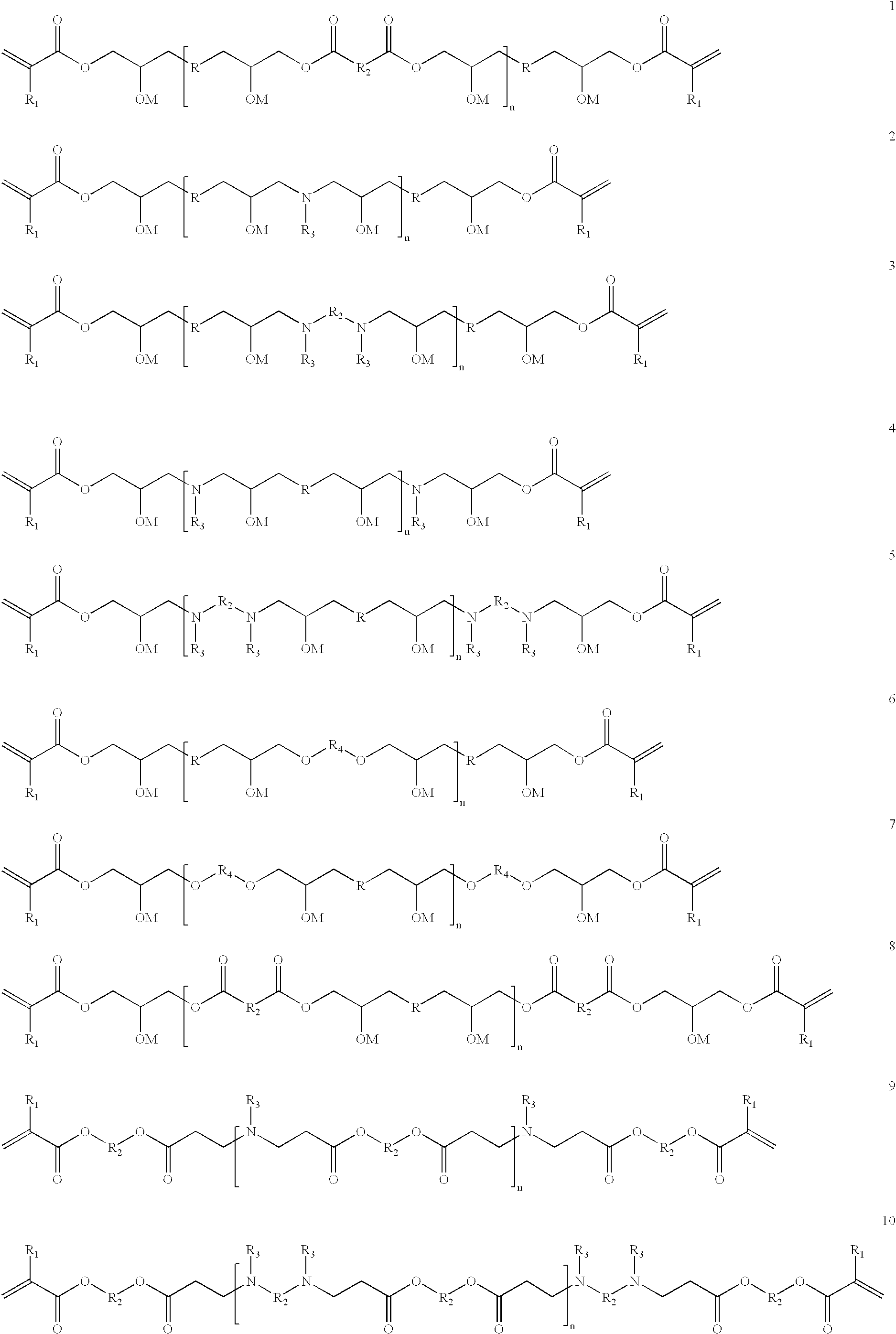

wherein

R is a residue derived from a diepoxide, notably a residue of the following formula

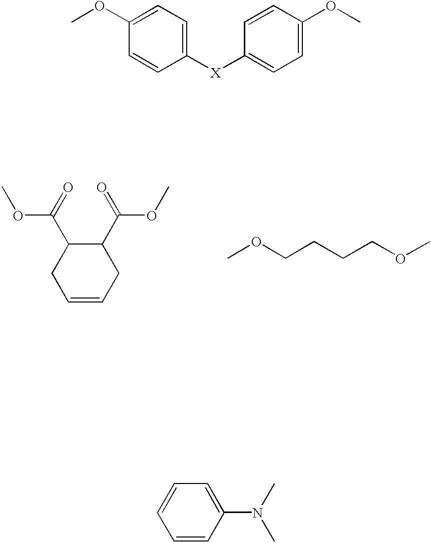

whereby X is C(CH₃)₂, —CH₂—, —O—, —S—, —CO—, —SO₂—

R₁ denotes hydrogen or a substituted or unsubstituted C₁ to C₁₈ alkyl, C₅ to C₁₈ substituted or unsubstituted cycloalkyl, substituted or unsubstituted C₅ to C₁₈ aryl or heteroaryl,

R₂ is a difunctional substituted or unsubstituted C₁ to C₁₈ alkylene, C₂ to C₁₂ alkenyl, C₅ to C₁₈ substituted or unsubstituted cycloalkylene, C₅ to C₁₈ arylene or heteroarylene,

R₃ denotes a substituted or unsubstituted C₁ to C₁₈ alkyl, C₂ to C₁₂ alkenyl, C₅ to C₁₈ substituted or unsubstituted cycloalkyl, C₆ to C₁₂ aryl or C₇ to C₁₂ aralkyl, or a siloxane moiety I, II or III

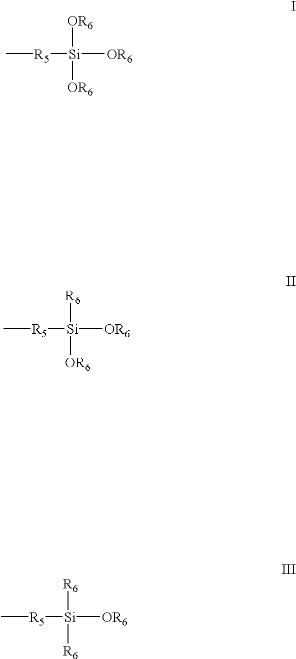

R₅ is a difunctional substituted or unsubstituted C₁ to C₁₈ alkylene, C₂ to C₁₂ alkenyl, C₅ to C₁₈ substituted or unsubstituted cycloalkylene, C₅ to C₁₈ arylene or heteroarylene, preferably CH₂CH₂CH₂,

R₆ denotes a substituted or unsubstituted C₁ to C₁₈ alkyl, C₂ to C₁₂ alkenyl, substituted or unsubstituted C₁ to C₁₈ alkylenoxy, C₅ to C₁₈ substituted or unsubstituted cycloalkyl, C₆ to C₁₂ aryl or C₇ to C₁₂ aralkyl,

R₄ is a substituted or unsubstituted C₆ to C₁₂ arylene, such as

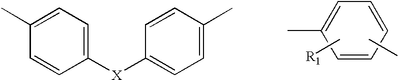

wherein X is C(CH₃)₂, —CH₂—, —O—, —S—, —CO—, —SO₂—,

M is a siloxane moiety I, II or III or it is a protection groups for hydroxylic moieties such as an ether, an ester or an urethane group,

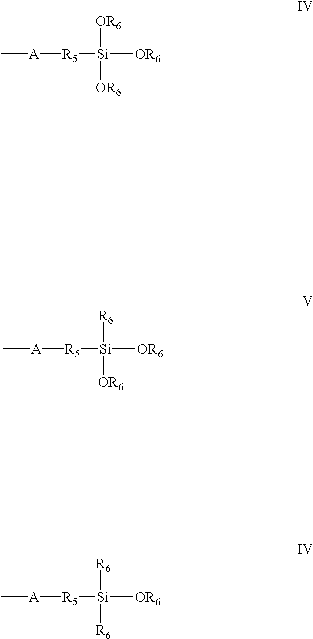

wherein A is an ether, an ester or an urethane linking group,

R₅ is a difunctional substituted or unsubstituted C₁ to C₁₈ alkylene, C₂ to C₁₂ alkenyl, C₅ to C₁₈ substituted or unsubstituted cycloalkylene, C₅ to C₁₈ arylene or heteroarylene,

R₆ denotes a substituted or unsubstituted C₁ to C₁₈ alkyl, C₂ to C₁₂ alkenyl, substituted or unsubstituted C₁ to C₁₈ alkylenoxy, C₅ to C₁₈ substituted or unsubstituted cycloalkyl, C₆ to C₁₂ aryl or C₇ to C₁₂ aralkylene,

and n is an integer.

Preferably macromonomers 1 to 3 and 6 to 8 are synthesized in presence of catalysts in substance or in solvents such as THF, toluene, triethyleneglycole bismethacrylate at temperatures between 60 and 100° C.

The reaction of macromonomers 4, 5 and 9-15 do not require catalysts and occur commonly at 20 to 80° C.

Maromonomers usable in dental/medical compositions comprising at least a macromonomer containing alkylsilyl, alkoxysilyl-, arylsilyl and/or aryloxysilyl groups, a polymerizable monomer, an organic or inorganic acid or a monomer that has at least an acidic moiety, a stabilizer, an initiator, pigments and an organic and/or inorganic filler.

For example a dental/medical composition comprise a macromonomer that is characterized by the following formulas:

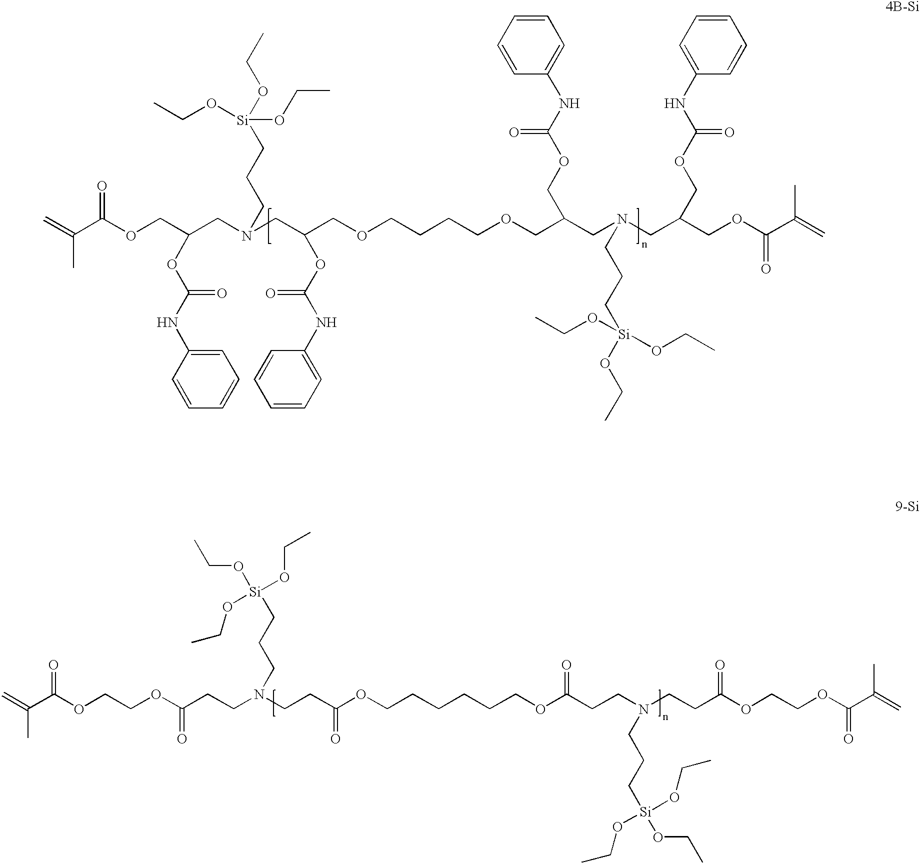

The polymerizable monomer of the dental/medical compositions is a mono- and polyfunctional (meth)-acrylate, such as a polyalkylenoxide di- and poly-(meth)acrylate, an urethane di- and poly(meth) acrylate, a vinyl-, vinylen- or vinyliden-, acrylate- or methacrylate; preferably were used diethyleneglycol dimethacrylate, triethyleneglycol dimethacrylate, 3,(4),8,(9)-dimethacryloyloxymethyltricyclodecane, dioxolan bismethacrylate, glycerol trimethacrylate, furfuryl methacrylate in a content of 5 to 80 wt-%.

Dental/medical compositions contains a polymerization initiator is a thermal initiator, a redox-initiator or a photo initiator.

Furthermore, a dental/medical composition contains a filler that preferably is an inorganic filler and/or an organic filler in an amount of 20 to 85% (w/w).

In order to avoid spontaneous polymerization a dental/medical composition contains a stabilizer, that preferably is a radical absorbing monomer such as hydrochinon monomethylether, hydrochinon dimethylether, BHT, phenothiazine.

Due to the siloxane moieties in macromonomers a second polymerization reaction occurs using an organic or inorganic acid as a catalyst. Preferably as organic acids p-toluene sulfonic acid and ascorbic acid are used. The preferred inorganic acids are sulfuric acid or phosphoric acid or organic derivatives of them. Most preferably pentaerythrol triacrylate monophosphate and dipentaerythol pentaacrylate monophosphate are used.

Furthermore, the macromonomers are usable for filler surface modification[CW6]. When the macromonomers are used the surface modification of the glass is carried out in an organic solvent such as acetone, THF or toluene or in the absence of any solvents. The surface modification is catalyzed by amines such as primary amines, primary tertiary amines primary secondary amines, secondary amines or tertiary amines or mixtures thereof. Preferably, as catalyst aminopropy triethoxysilane, 2-aminoethyl aminopropyl triethoxysilane or triethylamine are used.

The new macromonomers are useable as precursors for siloxane condensation products, too. These condensation products containing siloxane linkages and active polymerizable moieties are usable as monomers for dental materials. Furthermore, the new hybrid monomers are usable as precursor for the preparation of nanoparticles containing active polymerizable moieties.

The invented α,ω-methacrylate terminated macromonomers 1 to 9-15 or the obtained gels can polymerized using photochemical and radical initiated polymerization. The obtained networks show good mechanical properties, a good adhesion to surfaces of metals, glass and ceramics. Furthermore they show a relative low water absorption. Advantageously is the relative low shrinkage during the polymerization.

### EXAMPLE 1

40.000 g (117.50 mmol) bis-[4-(2,3-epoxypropoxy)phenyl]propane, 52.023 g (235.00 mmol) 3-aminopropyl triethoxysilan, 33.408 g 2,3-(epoxypropoxy) methyl methacrylate and 0.126 g 2,6-di-tert.-butyl-p-cresol were reacted for four hours at 90° C. The obtained methacrylate terminated macromonomer is soluble in organic solvents such as chloroform, DMF and THF. In the IR-spectrum was observed no absorption of epoxide groups at 915 and 3050 cm⁻¹. New absorption's was found at 1720 cm⁻¹ (ester groups) and 3400 cm⁻¹ (OH group).

Mₙ(vpo)=1050 g/mol, T_{g}=5.0° C., η_{(23° C.)}=50.4 Pa*s

(C₅₃H₉₀O₁₆N₂Si₂), 1067.49 g/mol

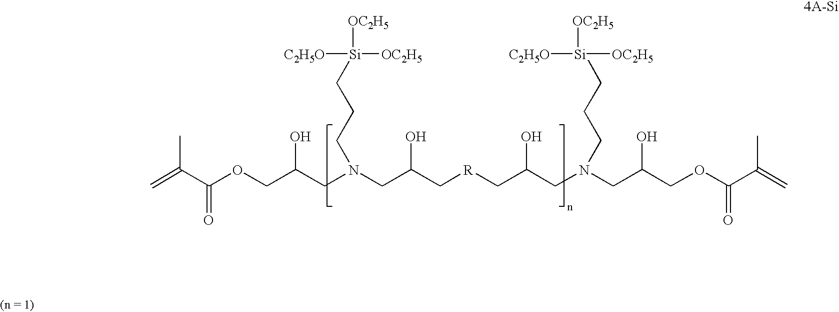

Condensation of —Si(OC₂H₅)₃ Groups

To 16.570 g (15.52 mmol) of macromonomer 4A-Si (n=1) dissolved in 80 ml THF were added 0.419 g (23.28 mmol) of water under stirring. The reaction mixture were stirred for additional 20 hours at ambient temperature. Then the solvent and ethanol were removed in vacuum and the condensation product was dried at 40° C. at 10 mbar.

### EXAMPLE 2

50.000 g (225.9 mmol) 3-aminopropyl triethoxy silan, 64.218 g (451.7 mmol) 2,3-(epoxypropoxy) methyl methacrylate and 0.1144 g 2,6-di-tert.-butyl-p-cresol were reacted for four hours at 90° C. The obtained methacrylate terminated macromonomer is soluble in organic solvents such as chloroform, DMF and THF. In the IR-spectrum was observed no absorption of epoxide groups at 915 and 3050 cm⁻¹. New absorption's was found at 1720 cm⁻¹ (ester groups) and 3400 cm⁻¹ (OH group).

(C₂₃H₄₃O₉NSi), 505.68 g/mol; η_{(23° C.)}=34 mPa*s

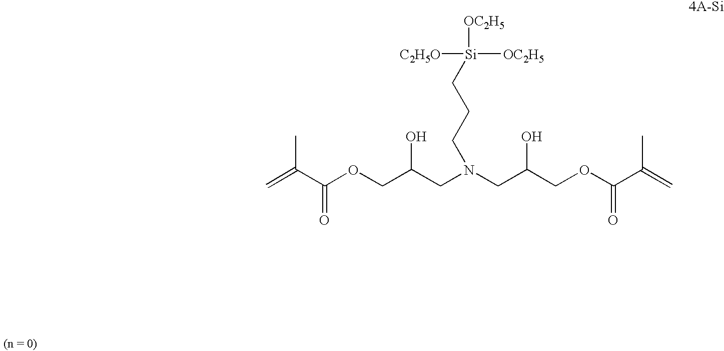

Condensation of —Si(OC₅)₃ Groups

To 19.260 g (38.09 mmol) of macromonomer 4A-Si (n=0) dissolved in 80 ml THF were added 1.029 g (57.13 mmol) of water under stirring. The reaction mixture were stirred for additional 20 hours at ambient temperature. Then the solvent and ethanol were removed in vacuum and the condensation product was dried at 40° C. at 8 mbar.

### EXAMPLE 3

A mixture of 50.000 g (0.247 mol) butanediole diglycidylether, 70.289 g (0.494 mol) 2,3-(epoxypropoxy) methyl methacrylate, 109.454 g (0.494 mol) 3-aminopropyltriethoxysilane and 0.230 g 2,6-di-tert.-butyl-p-cresol were reacted for 16 hours at 60° C.

Yield: 229.97 g (100%)

To 93.052 g (0.100 mol) of the reaction product were added drop-wise under stirring and cooling 47.750 g (0.401 mol) phenylisocyanate and 0.141 g di-tert.-butylsulfide.

Yield: 140.94 g (100%)

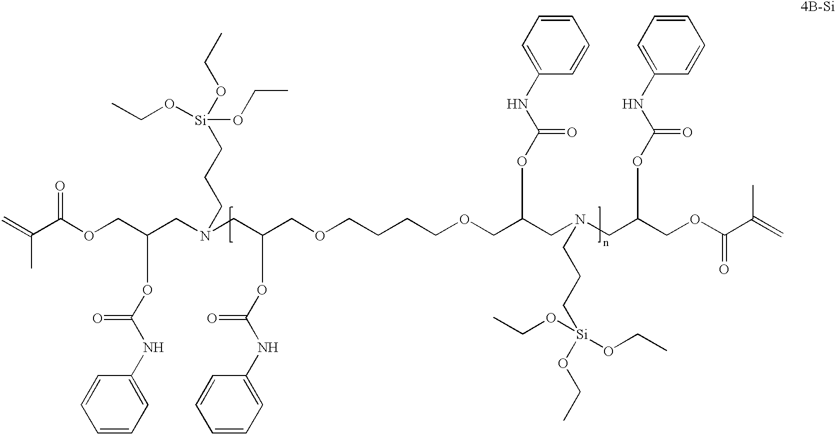

In the IR spectrum of the modified macromonomer 4B-Si absorption's at 3325 (NHCO), 1713 (CO), 1600 cm⁻¹ (Ph) were found. Absorption's of OH groups at 3425 and NCO groups at 2272 cm⁻¹ are completely missing.

### EXAMPLE 4

Synthesis of Ethyleneglycolacrylatmethacrylat (EGAMA)

In a three-necked bottle equipped with a stirrer, a thermometer and a dropping funnel a mixture of 143.80 g (1.105 mol) of 2-hydroxyethyl methacrylate and 123.00 g (1.216 mol) of triethylamine were dissolved in 800 ml of toluene. Under cooling (0-5° C.) 110.00 g (1.216 mol) of acryloyl chloride dissolved in 100 ml toluene were added during four hours. After standing over night, the precipitate was filtered off and washed twice with 20 ml of toluene. Then the reaction mixture was extracted twice with 200 ml water, with 150 ml 1 n HCl and with 150 ml 1 n NaHCO₃ and dried over NaSO₄. Thereafter the toluene was distilled off at 32 mbar and 40° C. and 0.2035 g BHT were added.

Yield: 156.71 g (77% of th.); bp. 70° C./ 8 mbar, n_{D}²⁰=1.4530

¹H NMR (CDCl₃)/ppm: 5.48/6.30 (1), 1.72 (3), 4.28 (5, 6), 5.73 (8), 6.03 (9)

¹³C NMR (CDCl₃)/ppm: 126.0 (1), 135.8 (2), 17.6 (3), 165.6 (4), 62.2 (5, 6), 167.1 (7), 128.0 (8), 131.1 (9)

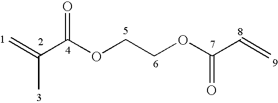

Macromonomer 9-Si (n=0):

20.232 g (109.8 mmol) EGAMA, 12.158 g (54.9 mmol) aminopropyl triethoxysilane and 0.032 g BHT were mixed homogeneously and stirred at room temperature for 12 hours.

C₂₇H₄₇NO₁₁Si, 589.75 g/mol; m/z (FAB-MS)=590.

Condensation of —Si(OC₂H₅)₃ Groups

To 12.000 g (11.57 mmol) of macromonomer 9-Si dissolved in 50 ml THF were added 0.313 g (17.35 mmol) of water under stirring. The reaction mixture were stirred for additional 20 hours at ambient temperature. Then the solvent and ethanol were removed in vacuum and the condensation product was dried at 40° C. at 8 mbar.

### EXAMPLE 5

### Macromonomer 9-Si, n=1

24.643 g (133.8 mmol) EGAMA and 0.062 g BHT were dissolved in 100 ml methanol. To this mixture 25.600 g (133.8 mmol) aminopropyl triethoxysilane were added at 0-5° C. and stirred for 2 hours. Then the methanol was distilled off and the mixture was reacted for a further 24 hours at 23° C.

C₄₂H₇₆N₂O₁₆Si₂, 921.24 g/mol

### EXAMPLE 6

### Macromonomer 15-Si

26.777 g (145.4 mmol) EGAMA, 10.000 g (48.5 mmol) 2-aminoethyl aminopropyl methyl dimethoxysilane and 0.037 g BHT were mixed homogeneously and stirred at room temperature for 12 hours.

C₃₅H₅₈N₂O₁₄Si, 758.93 g/mol; m/z (FAB-MS)=759, n_{D}²⁰=1.4749, η_{(23° C.)}=144 Pa*s.

### APPLICATION EXAMPLE 7

### Filler Surface Modification

3-aminopropyl-methyl-diethoxysilane/EGAMA adduct In a three-necked flask with a dropping funnel, dimroth cooler, CaCl₂-drying tube, thermometer and magnetic stirrer 79.956 g (434.1 mmol) EGAMA and 0.121 g BHT are dissolved in 210 ml THF. At a temperature of 0-5° C. 41.530 g aminopropyl methyl-diethoxysilane in 25 ml THF are added by dropping over a period of 60 min. Afterwards the solution is stirred at room temperature for additional four hours. The solvent is evaporated under reduced pressure of 8 mmbar and a bath temperature of 40° C. The remaining mixture is stirred for additional 24 h at 23° C. and 5 hours at 40° C. The addition product APDES/EGAMA was characterized by FAB-MS m/z 560, n_{D}²⁰=1.4600, η_{(23° C.)}=40 mPa*s.

C₂₆H₄₅NO₁₀Si, 559.72 g/mol.

Modified Inorganic Glass Filler (3.0%):

50 g of an barium alumo silicate glass having a particle size of 0.9-1.5 μm is dispersed in 250 ml of acetone. 1.5 g of the adduct of 3-aminopropylmethyl-diethoxysilane/EGAMA is added, 2.0 g of diethylamine and 1.0 g of water are added to the dispersion. The dispersion is stirred at 60° for 6 h. The solvent is evaporated. For the silanation the remaining solid is stored at 1150 for 15-18 h under reduced pressure (20 mbar) and sieved through a 220 μm sieve.

To control the success of the silanation a part of the silanated glass was stirred in acetone for 5 h. The solvent was filtered. The remaining glass was washed with acetone. The solutions were dried and the residue of non bonded silane on the glass was weighted. 20.2% silane were found in the solution. The remaining 79.8% were bond to the glass surface. Therefore the glass has a total silane content of 2.4%

The obtained modified glass filler is used in dental/medical composite.

1. Dental/Medical Composite Resin

28.900 g 2,2-Bis-[p-(2-hydroxy-3-methacryloyloxypropoxy)-phenyl]-propane (Bis-GMA), 31.225 g triethylene glycol dimethacrylate, 31.226 g ethoxylated bisphenol-A-dimethacrylate, 8.198 g hexamethylenediisocyanate, 0.330 g dibutyltindilaurate and 0.100 g BHT are mixed in a 250 ml beaker by stirring at 40° C.

The obtained resin is used directly for the preparation of a dental/medical composite.

Activated Resin

99.35 g resin as described above, 0.30 g camphor quinone and 0.35 DMABE are mixed in a 250 ml beaker by stirring at 40° C.

2. Dental/Medical Composite

240 g activated resin as described above are mixed with 760 g of modified inorganic glass filler as described above by the use of an planetary mixer under exclusion of daylight. The glass is successively added in five steps of 400 g, 150 g, 100, 50 g and 50 g. After getting a homogeneous paste the mixture is evaporated at a pressure of 180-220 mbar. For conditioning the paste is stored under exclusion of daylight for additional 24 h at 40° C.

3. Properties of Dental/Medical Composites

Dental/medical composites obtained according the method described above were tested on their mechanical properties on a standard testing machine (Zwick Z 010). The compressive strength was measured according to the ISO standard 9917, 1991 (dental water based cements), the flexural strength was measured according to ISO 4049, 1988 (dental composite materials).

The consistency of the composites were measured as following: To portion 0.5 ml of the composite it is filled into a cylindrical hole of a diameter of 0.7 ml and a height of 1.3 mm. The composite is dosed on a surface of a polyetherketone foil and load with a weight of 575 g over a period of 30 sec. Afterwards the diameter of the obtained composite circle is measured in mm and noted as the consistency of the material.

The volumetric shrinkage is measured in two different ways. According to the Archimedes method by measuring the change of the density as a result of the polymerization reaction and by measuring the linear dimensional change after the polymerization. The linear dimensional change was afterwards calculated to a volumetric shrinkage (ZH-method).

All results are shown in the table below.

| | | MS-8.125.1 | MS-8.125.2 | MS-8.130.1 |
|---|---|---|---|---|
| Type of silane | | EGAMA- | EGAMA- | A-174 |
| | | APDES | APDES | |
| Silane content on glass | % | 2.5 | 4.0 | 3.0 |
| Filler content | % | 75.0 | 76.2 | 75.0 |
| Compr. strength | MPa | 287.1 ± 20.9 | 282.5 ± 12.3 | 349.5 ± 9.7 |
| Flexural strength | MPa | 103.4 ± 11.2 | 101.7 ± 4.3 | 126.3 ± 11.3 |
| E-Modulus | MPa | 7381 ± 300 | 6948 ± 700 | — |
| Volumetric shrinkage | % | 3.21 ± 0.09 | 3.31 ± 0.06 | 3.00 ± 0.48 |
| (Archimedes-method) | | | | |
| Volumetric shrinkage | % | 1.38 ± 0.20 | 1.33 ± 0.11 | 1.63 ± 0.14 |
| (ZH-method) | | | | |
| Consistency | mm | 10.5 | 11.0 | 10.0 |

### APPLICATION EXAMPLE 8

### Condensation to Nanoparticles in TGDMA

1 g (1.8 mmol) addition product of EGAMA and aminopropyl trimethoxysilane were dissolved in 9 g TGDMA. To this solution were added 0.15 g (8.2 mmol) water. Then this mixture and stirred for 14 days at room temperature. The formed particles have an average particle size of 3 nm. The Transmission electron microscopic photograph (Error! Reference source not found.) show the formed nano-scaled particles. In the IR spectrum double bonds of the methacrylate groups were found at 1720 cm⁻¹.

### APPLICATION EXAMPLE 9

### Condensation to Nanoparticles

1 g (1.8 mmol) addition product of EGAMA and aminopropyl trimethoxysilane were dissolved in 10 ml ethanol. To this solution were added 1.08 g water and 0.51 g of acetic acid and stirred for 14 days at room temperature. The formed particles have an average particle size of 6.6 nm.

In the Element specific image of the Transmission electron microscopic photograph (Error! Reference source not found.) the silcium atoms of nano-scaled particles were found. These particles were observed in the Transmission electron microscopic photograph (Error! Reference source not found.), too. In the IR spectrum double bonds of the methacrylate groups were found at 1720 cm

### APPLICATION EXAMPLE 9

### Preparation a Composite

0.035 g camphor quinone and 0.035 g dimethylamino benzoic acid ethyl ester were added to 3.00 g of the addition product of EGAMA and aminopropyl diethoxymethylsilane and 7.00 g Bis-GMA. To this mixture silanized Spectrum glass (Schott) was added so that composites with about 70% share filler were obtained. Then the composite was homogenized by stirring at 40° C. for 30 min and then degassed at 200 mbar and 60° C. for 15 min. The photochemical polymerization of these samples was carried out in a Triad photochemical curing unit (Dentsply De Trey, Konstanz) within 4 minutes.

The composite shows a compressive strength of 291.3 MPa a flexural strength of 53 MPa and an E-modulus of 3830 MPa. The volumetric shrinkage is 1.79% at an degree of conversion of 0.86 (measured by using of DSC).

We claim:

1. A macromonomers comprising a molecular weight of at least about M≧500 g/mol containing siloxane groups that are characterized by the following formula: 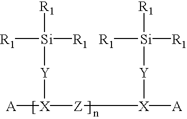
wherein
A is a polymerizable moiety;
R₁ is a C₁ to C 18 oxyalkyl, a C₅ to C₁₈ oxycycloalkyl or a C₅ to C₁₅ oxyaryl, C₁ to C₁₈ alkyl, a C₅ to C₁₈ cycloalkyl or a C₅ to C₁₅ aryl or heteroaryl;
X is N or a substituted or unsubstituted C₁ to C₁₈ alkylene, a C₁ to C₁₈ oxyalkylene or C₁ to C₁₈ carboxyalkylene;
Y is a C₁ to C₁₈ alkylene, C₁ to C₁₈ oxyalkylene or a urethane —O—CO—NH— linking moiety;
Z is a C₁ to C₁₈ alkylene, a C₅ to C₁₈ cycloalkylene or a C₅ to C₁₅ arylene or heteroarylene, and
n is an integer.

2. A macromonomer as in claim 1, wherein said polymerizable moiety has an olefinic double bond.

3. A macromonomer as in claim 2, wherein said polymerizable moiety is selected from the group consisting of acrylate and methacrylate.

4. A macromonomers comprising: 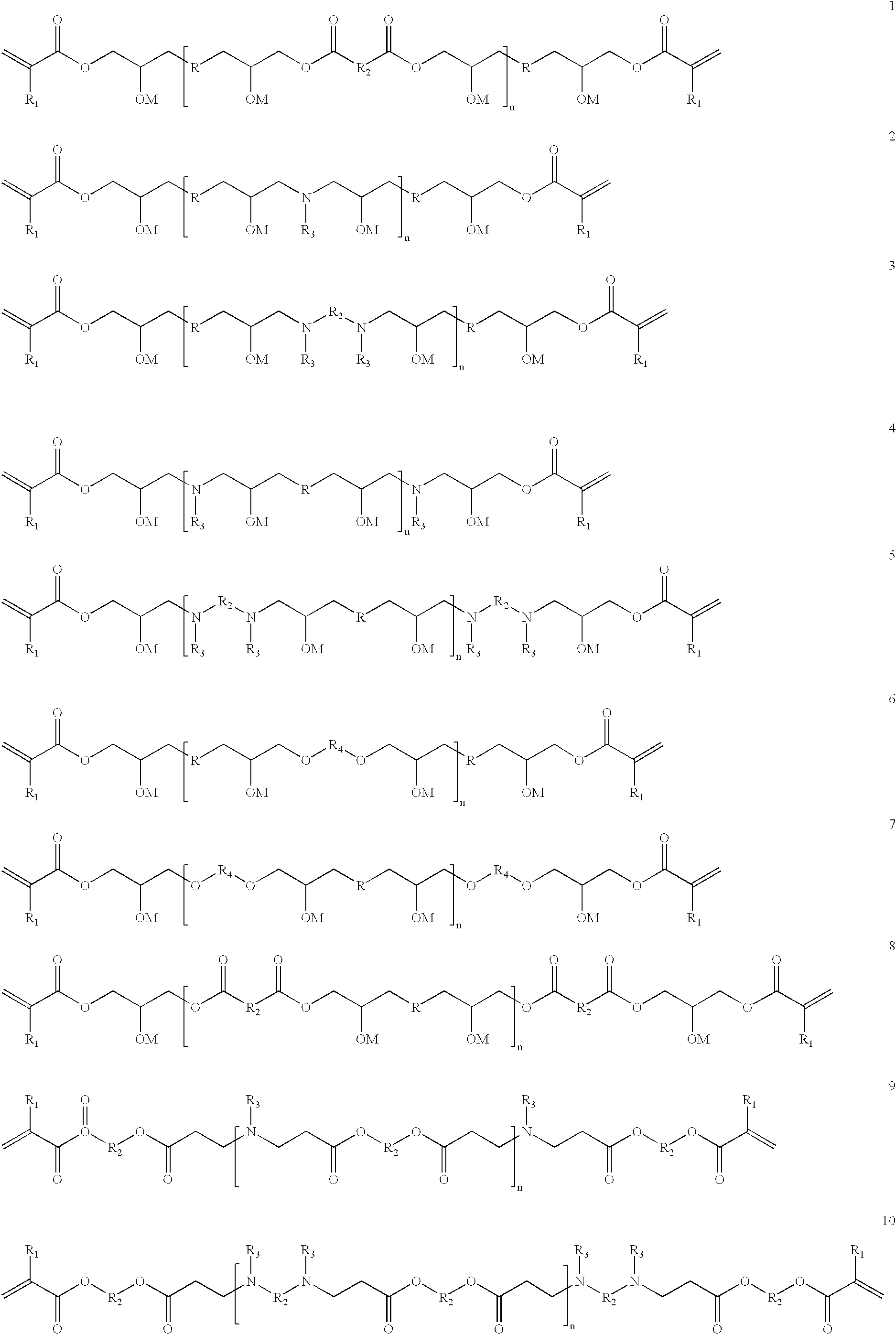
wherein
R is a residue derived from a diepoxide and having a formula selected from the group consisting of i, ii, iii, iv as follows: 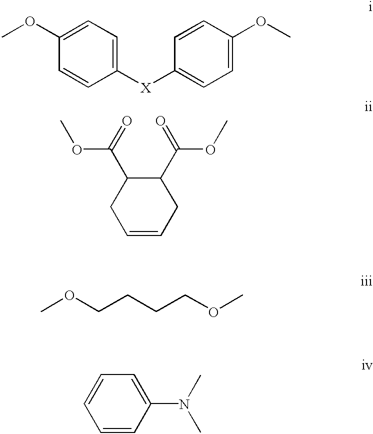
whereby X is C(CH₃)₂, —CH₂—, —O—, —S—, —CO—, —SO₂—;
R₁ denotes hydrogen or a substituted or unsubstituted C₁ to C₁₈ alkyl, C₅ to C₁₈ substituted or unsubstituted cycloalkyl, substituted or unsubstituted C₅ to C₁₈ aryl or heteroaryl,
R₂ is a difunctional substituted or unsubstituted C₁ to C₁₈ alkylene, C₂ to C₁₂ alkenyl, C₅ to C₁₈ substituted or unsubstituted cycloalkylene, C₅ to C₁₈ arylene or heteroarylene,
R₃ denotes a substituted or unsubstituted C₁ to C₁₈ alkyl, C₂ to C₁₂ alkenyl, C₅ to C₁₈ substituted or unsubstituted cycloalkyl, C₆ to C₁₂ aryl or C₇ to C₁₂ aralkyl, or a siloxane moiety I, II or III 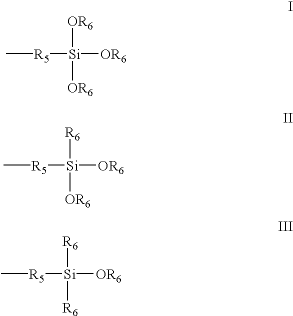
R₄ is a substituted or unsubstituted C₆ to C₁₂ arylene
R₅ is a difunctional substituted or unsubstituted C₁ to C₁₈ alkylene, C₂ to C₁₂ alkenyl, C₅ to C₁₈ substituted or unsubstituted cycloalkylene, C₅ to C₁₈ arylene or heteroarylene, preferably CH₂CH₂CH₂,
R₆ denotes a substituted or unsubstituted C₁ to C₁₈ alkyl, substituted or unsubstituted C₁ to C₁₈ alkylenoxy, C₂ to C₁₂ alkenyl, C₅ to C₁₈ substituted or unsubstituted cycloalkyl, C₆ to C₁₂ aryl or C₇ to C₁₂ aralkyl,
M is a siloxane moiety I, II or III or it is a protection groups for hydroxylic moieties selected from the group consisting of an ether, an ester or a urethane group,
R₅ is a difunctional substituted or unsubstituted C₁ to C₁₈ alkylene, C₂ to C₁₂ alkenyl, C₅ to C₁₈ substituted or unsubstituted cycloalkylene, C₅ to C₁₈ arylene or heteroarylene,
R₆ denotes a substituted or unsubstituted C₁ to C₁₈ alkyl, C₂ to C₁₂ alkenyl, substituted or unsubstituted C₁ to C₁₈ alkylenoxy, C₅ to C₁₈ substituted or unsubstituted cycloalkyl, C₆ to C₁₂ aryl or C₇ to C₁₂ aralkyl,
and n is an integer.

5. A macromolecule as in claim 4, wherein R₄ is selected from VII and VIII as follows: 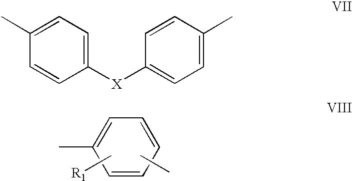
wherein X is C(CH₃)₂, —CH₂—, —O—, —S—, —CO—, or, —SO₂—.

6. A macromolecule as in claim 4, wherein M is selected from the group consisting of 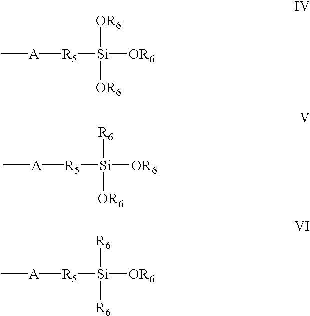
wherein A is an ether, an ester or an urethane linking group.

7. A macromonomer of claims 1 synthesized in presence of catalysts or in solvents selected from the group consisting of THF, toluene and triethyleneglycol bismethacrylate.

8. Macromonomers of claim 1 wherein said macromonomer is characterized by the following formula:

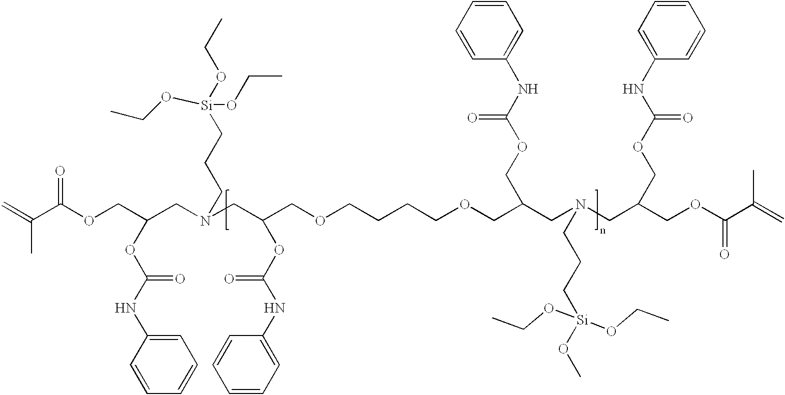

9. Macromonomers of claim 1 wherein said macromonomer is characterized by the following formula:

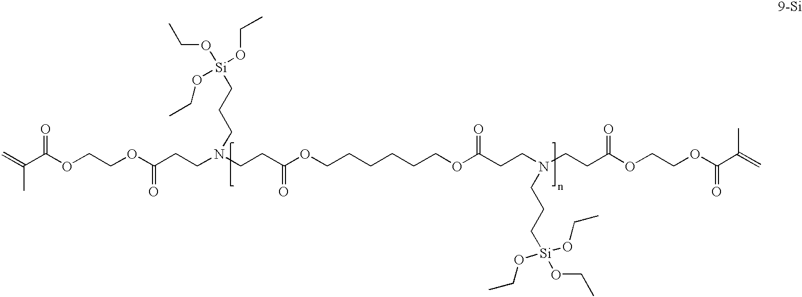

10. A composition comprising the macromonomer of claim 1 usable
a) as monomers in dental composition that further comprises a polymerizable monomer, an organic or inorganic acid or a monomer that has at least an acidic moiety, a stabilizer, an initiator, pigments and an organic or inorganic filler; or
b) for filler surface modification or
c) as precursor for siloxane condensation products containing active polymerizable moieties
d) as precursor for preparation of nanoparticles containing active polymerizable moieties.

11. A composition as in claim 6 comprising at least a macromonomer containing at least one siloxane group, a polymerizable monomer, an organic or inorganic acid or a monomer that has at least an acidic moiety, a stabilizer, an initiator, pigments and an organic and/or inorganic filler.

12. A composition as in claim 11 wherein said polymerizable monomer is a mono- and polyfunctional (meth)acrylate, in a content of 5 to 80 wt-%.

13 A composition as in claim 12, wherein said polymerizable monomer is selected from the group consisting of polyalkylenoxide di- and poly(meth)acrylate, urethane di- and poly(meth)acrylate, and vinyl-, vinylen-, vinyliden-acrylate- or methacrylate, alkoxysilyl(meth)acrylate.

14 a composition as in claim 13, wherein said polymerizable monomer is selected from the group consisting of diethylene glycol dimethacrylate, triethylene glycol dimethacrylate, 3,(4),8,(9)-dimethacryloyloxymethyltricyclo decane, dioxolan bismethacrylate, glycerol trimethacrylate, and furfuryl methacrylate.

15. A composition as in claim 11 wherein said organic acid is selected from the group consisting of p-toluene sulfonic acid, ascorbic acid, citric acid, and maleic acid.

16. A composition as in claim 11 wherein said acidic polymerizable monomer is selected from the group consisting of pentaerythrol triacrylate monophosphate, dipentaerythrol pentaacrylate monophosphate, methacrylic acid, and acrylic acid.

17. A macromonomer as in claim 1 wherein said polymerization initiator is a thermal initiator, a redox-initiator or a photo initiator.

18. A macromonomer as in claim 17 wherein said photo initiator is chamfer quinone an/or a diaryliodonium salt, a triarylsulfonium salt or a pyridinium salt.

19. A macromonomer as in claim 11 wherein said filler is an inorganic filler and/or an organic filler.

20. A macromonomer as in claim 11 wherein said stabilizer is a radical absorbing monomer such as hydrochinonmonomethylether, hydrochinondimethylether, BHT, phenothiazine.

21. A macromonomer as in claim 11 that is usable as dental restorative material for filling and restoring teeth, making inlays and onlays, as core build-up materials, for artificial teeth, for sealing and surface modification materials or that is usable as temporary crown and bridge material.

22. A macromonomer as in claim 11 that is usable as a temporary crown and bridge material.

23. A macromonomer as in claim 10 that comprises an inorganic or organic filler that is modified using siloxane containing macromonomers of claim 1.

24. Macromonomers of claim 10 usable for filler surface modification that occurs in combination with basic catalysts selected from the group consisting primary amines, primary tertiary amines primary secondary amines, secondary amines, tertiary amines and mixtures thereof in, optionally in the presence of solvents.

25. Macromonomers of claim 10 usable as precursors for siloxane condensation products containing active polymerizable moieties that are applicable as polymerizable monomers for dental material optionally in presence of further hydrolysable compounds of Silicium or Ba, B, Al, Tl, In or other transition element.
